(19) United States
(12) Patent Application Publication
(10) Pub. No.: US 2026/0117730 A1
(43) Pub. Date: Apr. 30, 2026

(54) LOCATING A FUEL LEAK IN A FUEL SYSTEM

(71) Applicant: OPmobility C-Power Belgium Research, Woluwe-Saint-Lambert (BE)

(72) Inventors: Krzysztof POTACZEK, Bruxelles (BE); Laurent DUEZ, Bruxelles (BE); Eric CAPRON, Bruxelles (BE); Emile BERTRAND, Bruxelles (BE)

(73) Assignee: OPmobility C-Power Belgium Research, Woluwe-Saint-Lambert (BE)

(21) Appl. No.: 19/473,671

(22) PCT Filed: Apr. 17, 2024
(86) PCT No.: PCT/EP2024/060346

§ 371 Date: Oct. 8, 2025

(30) Foreign Application Priority Data
Apr. 18, 2023 (BE) BE2023/5290

(51) Int. Cl. F02M 25/08

(52) U.S. Cl. CPC F02M 25/0809; F02M 25/0836

(57) ABSTRACT

A method for locating a fuel leak in a pressurized fuel system for a vehicle provided with a combustion engine includes: carrying out a first test to determine a fuel leak in the system including a first container and a second container that are openly connected to each other; and when a fuel leak is determined upon completion of the first test: closing the connection between the first container and the second container so as to isolate the two containers from one another; carrying out a second test for determining the presence or absence of a fuel leak in the first container; and when a fuel leak is detected upon completion of the second test, concluding a fuel leak is located in the first container or, if a fuel leak is not detected upon completion of the second test, concluding a fuel leak is located in the second container.

The invention relates to locating a fuel leak in a fuel system for a vehicle, in particular after a combustion engine of the vehicle has been stopped. More particularly, it relates to a passive location method, that is, a method which does not require the generation of suction or the vacuuming the fuel system, or any other mechanical operation on the containers.

A method for passively determining the presence or absence of a fuel leak in a pressurized fuel system of a vehicle provided with a combustion engine is already known in the state of the art, especially from document EP3409936. This method is carried out after the combustion engine has been stopped. It comprises steps of measuring pressures and temperatures at certain times over a period of time, then steps of calculating a first maximum temperature difference between these times. If this first temperature difference is greater than a predetermined temperature difference threshold, the method comprises a step of calculating a pressure difference between the two corresponding times. If this pressure difference is below a predetermined pressure difference threshold, the method concludes that there is a fuel leak in the fuel system.

One shortcoming of this method is that, if a conclusion is reached regarding the presence of a fuel leak, it is not possible to locate the fuel leak in the system. As a consequence, to fix the fuel leak, it is necessary to remove or even replace the entire system, which is complex and costly.

U.S. Pat. No. 11,542,896, CN113389 and KR20170131610 teach respective methods for detecting leaks in a fuel system.

The invention especially aims to make it possible to locate a fuel leak in a fuel system, whether the fuel is liquid and/or gaseous, using a passive method.

To this end, the invention relates to a method for locating a fuel leak in a pressurized fuel system for a vehicle provided with a combustion engine, comprising the following steps:
since the system comprises a first container and a second container openly connected to each other, a first passive test for determining the presence or absence of a fuel leak in said system comprising the first container and the second container;
when the presence of a fuel leak is determined upon completion of the first passive test:
closing the connection between the first container and the second container so as to isolate the two containers from one another;
carrying out a second passive test to determine the presence or absence of a fuel leak in the first container;
when the presence of a fuel leak is detected upon completion of the second passive test, concluding that a fuel leak is located in the first container, or when the absence of a fuel leak is detected upon completion of the second passive test, concluding that a fuel leak is located in the second container, the first and second passive tests being passive since they do not require the generation of suction or vacuuming the fuel system or any other mechanical operation on the first container and the second container.

Thus, by virtue of the second passive test carried out once the first container and the second container have been isolated from one another, the fuel leak detected upon completion of the first passive test can be located as being in either the first container or in the second container. This method therefore makes it possible to locate the fuel leak, either in the first container or in the second container, simply by closing a connection and performing a second passive test for detecting a fuel leak. It is therefore particularly easy to carry out. It only requires one test to determine the presence or absence of a fuel leak in a fuel system to be carried out in one container and a means for closing a connection between the container and another container in the system. These two elements, the passive determination test and the means for closing the connection, may already exist in a vehicle, so that the location method is simple and inexpensive to implement. In this way, only the faulty container is removed and/or changed in order to repair the fuel leak, rather than the two containers as a whole.

The term “fuel system” refers to any device incorporated into a vehicle provided with a combustion engine, the function of which is to store, purify, measure or transport a fuel intended to supply the combustion engine. A fuel system comprises at least one fuel tank and a fuel supply pipe to the combustion engine. It may also comprise one or more of the following accessories: fuel tank vent valve and pipe, filler pipe, canister, fuel filter, fuel pump, fuel tank gauge, electrical connector, closing cap, and any other device through which liquid or gaseous fuel passes, for example, a fuel vapor circulation pipe.

The vehicle provided with a combustion engine can especially be a hybrid vehicle.

The following are other optional features, taken either alone or in combination.

Preferably, the first passive test comprises the following steps:
after the combustion engine of the vehicle has been stopped, measuring respective pressure values in the system at various predetermined times over a period of time;
determining, among the times, the two times at which the respective pressure values are farthest from one another;
when an absolute pressure difference value between these two values is smaller than or equal to a predetermined pressure difference threshold, concluding that there is a fuel leak in the system and stopping the method.

Thus, it is sufficient to take pressure measurements over a period of time and to determine the maximum pressure deviation, that is, between the lowest pressure measured and the highest pressure measured over this period of time, to conclude that there is a fuel leak. This method is based on the observation that, below a predetermined pressure difference threshold, that is, with a particularly small change in pressure over time in relation to the period under consideration, it can be reliably concluded that there is a fuel leak in the fuel system, without having to take temperatures into account. This method is therefore particularly easy to carry out.

It is noted that if no conclusion is reached upon completion of these steps regarding the presence of a fuel leak, it is not necessarily concluded that there is no fuel leak. Further steps can then be carried out to seek one or the other of these conclusions.

A “time” is understood to be a point in a period of time associated with a pressure in the fuel system.

Advantageously, the first and second passive tests for determining the presence or absence of a fuel leak comprise steps of:
measuring pressure and temperature values in the first container of the system at various predetermined times in respective first and second time periods;
comparing at least one of the values with a predetermined threshold.

Thus, the test carried out twice to determine the presence or absence of a fuel leak comprises simple steps of measuring temperatures and pressures in the one or more containers and comparing them with threshold values.

Preferably, the first passive test is carried out following a stopping of the combustion engine of the vehicle and for a predetermined period of time, preferably at least four hours, in particular at least six hours.

In this way, the invention is particularly suitable for complying with the US standard referred to as CARB (California Air Resources Board), which requires a six-hour observation period.

Advantageously, the second passive test is carried out immediately after the end of the first passive test when the presence of a fuel leak has been detected upon completion of this first passive test.

Thus, if a fuel leak is detected upon completion of the first test, the connection between the two containers is immediately closed and the second test begins to locate this fuel leak.

Preferably, the second passive test is continued for a predetermined period of time, preferably at least two hours.

Thus, the second test is economical, since it is stopped in a predetermined way.

Alternatively, the second passive test is continued until the vehicle provided with a combustion engine is restarted.

The second test herein is less economical, but since it lasts until the vehicle is restarted, it is likely to include more measurements taken, since the time period can be extended. It therefore increases the probability of locating the fuel leak, since the more measurements there are and the longer the period of time, the more likely it is that a fuel leak will be detected.

Alternatively, since the stopping of the combustion engine is a first stop, the second passive test is carried out after a second stopping of the combustion engine following a restart of the engine subsequent to the first passive test, the second passive test being continued for a predetermined period of time, preferably at least six hours.

Thus, the second test starts only in the “next cycle”, that is, after the combustion engine has been stopped again. This alternative is therefore even more economical than the previous two, and requires more time to locate the fuel leak, since it is necessary to wait for this new cycle. However, in this alternative, the second test is more efficient than in the two previous alternatives, and as efficient as the first, since it is carried out under the same conditions as the first test: it starts as soon as the combustion engine is stopped and can last for a sufficiently long time, for example six hours.

Advantageously, if no conclusion is reached regarding the location of the fuel leak upon completion of the second passive test, after stopping the combustion engine following a restart of the combustion engine after the second test, the method comprises the following steps:
closing the connection between the first container and the second container of the system so as to isolate the two containers from one another;
carrying out a third passive test to determine the absence or presence of a fuel leak in the first container of the system, continued for a predetermined period of time, preferably at least six hours, the third test being passive since it does not require the generation of suction or vacuuming the fuel system or any other mechanical operation on the first container and the second container.

Thus, if the fuel leak has not been located upon completion of the second test, and when the vehicle is back on the road, this second test is repeated on the next cycle. This is the “third test”. This ensures that the fuel leak is located, even if it takes some time, rather than starting the fuel leak detection process again from scratch with the first test.

Preferably, the first container of the system is a fuel tank and the second container is a canister, the opening and closing of the connection being operated by a valve.

Thus, the first test makes it possible to detect a fuel leak in the sub-assembly formed by the tank and the canister, and the second test makes it possible to locate the fuel leak in either the tank or the canister.

The invention also contemplates a data-processing device which comprises a processor suitable for the steps of the method described hereinbefore, in order to carry out said steps of this method.

This device is, in particular, a control unit integrated into the vehicle.

Also provided according to the invention is a fuel system for a vehicle provided with a combustion engine, comprising:
a first container and a second container connected to each other;
a valve for opening and closing the connection between the first container and the second container;
a device as described hereinbefore for carrying out the steps of the method described hereinbefore.

The valve can be a standard isolation valve, for example of the FTIV type (fuel tank isolation valve) if the two containers are a tank and a canister, or a double-valve stage comprising another stage for opening and closing the connection between the second container and the atmosphere.

The invention also provides a vehicle provided with a combustion engine comprising a fuel system as described hereinbefore.

The invention also provides a computer program comprising instructions which, when the program is executed by a computer, cause the computer to carry out the steps of the method as described hereinbefore.

The invention also provides a computer-readable storage medium comprising instructions which, when executed by a computer, cause the computer to carry out the steps of the method as described hereinbefore.

### BRIEF DESCRIPTION OF THE FIGURES

The invention will be better understood upon reading the following description, which is provided merely as example and with reference to the appended drawings, wherein:

FIG. 1 is a schematic view of a fuel system according to the invention;

FIG. 2 is a schematic view of the system of FIG. 1 in a different configuration

FIG. 3 is a diagram of a method for detecting a fuel leak; and

FIG. 4 is a diagram of a method for locating a fuel leak according to the invention;

### DETAILED DESCRIPTION

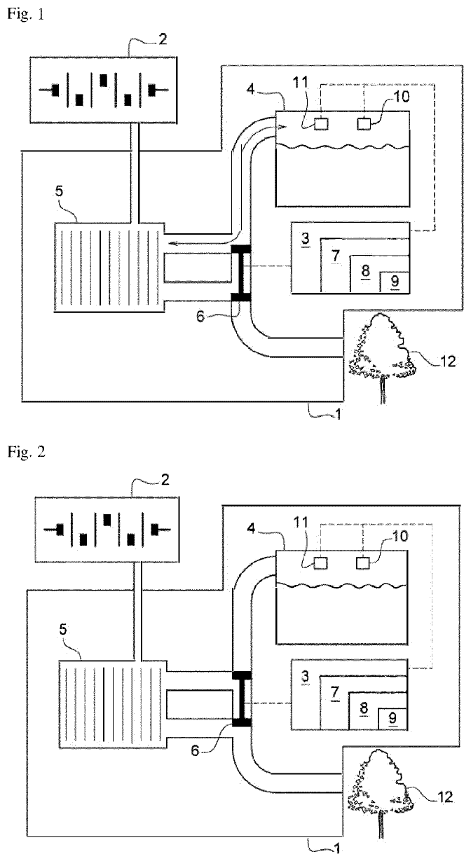

FIGS. 1 and 2 depict one embodiment of a fuel system 1 of the invention. This fuel system 1 is a pressurized fuel system for a combustion engine 2 of a vehicle. It is integrated into a vehicle in a manner that is not shown. The vehicle may or may not be a hybrid. The system comprises a data-processing device 3, a fuel tank 4, a canister 5 and a double valve 6.

The data-processing device 3 comprises a processor 7 suitable for the steps of the methods 100 and 400 described hereunder to carry out the steps of these methods 100 and 400. The term “suitable” means that the processor 7 is particularly configured to carry out these methods. The data-processing device 3 also comprises a computer-readable storage medium 8 containing instructions which, when executed by a computer, more particularly by the processor 7, cause the computer to carry out the steps of the method 100 and the method 400. In particular, this storage medium 8 contains a computer program 9 comprising instructions which, when the program 9 is executed by a computer, in particular by the processor 7, cause the computer to carry out the steps of the method 100 and the method 400. In the present example, the data-processing device 3 is an electronic control unit (ECU), the processor 7 is a microprocessor and the computer-readable storage medium 8 is a non-volatile memory suitable for storing the computer program 9.

The fuel tank 4 comprises a fuel having a liquid phase and a gaseous phase, shown diagrammatically on either side of the wave-shaped line. The fuel tank 4 comprises a temperature sensor 10 and a pressure sensor 11, located in the top of the fuel tank 4, that is, in the area of the fuel tank 4 in which fuel in gaseous phase is present under normal vehicle operating conditions. This pressure sensor 11 and this temperature sensor 10 are connected to the data-processing device 3.

The canister 5 is connected to a combustion engine 2 of the vehicle by means that are not described herein.

The canister 5 is connected to the fuel tank 4 and to the atmosphere 12, illustrated by a tree, by respective pipes that are schematically illustrated, and by the double valve 6.

The double valve 6 makes it possible to open and close the connections between the canister 5 and the fuel tank 4, as well as between the canister 5 and the atmosphere 12. This double valve 6 is preferably a solenoid valve, controlled by the data-processing device 3. This double valve 6 may be replaced by two discrete valves, in particular by a FTIV-type valve (fuel tank isolation valve) for opening and closing the connection between the fuel tank 4 and the canister 5, and a CVS-type valve (canister isolation valve) for opening and closing the connection between the canister 5 and the atmosphere 12.

In FIG. 1, the double valve 6 is configured to leave the connection between the canister 5 and the fuel tank 4 open, and to close the connection between the canister 5 and the atmosphere 12. Thus, the fuel tank 4 and the canister 5 form a system that is isolated from the outside.

In FIG. 2, the double valve 6 is configured to close the connection between the canister 5 and the fuel tank 4, the connection between the canister 5 and the atmosphere also remaining closed. Thus, both the fuel tank 4 and the canister 5 are isolated from the atmosphere and from one another.

### I. Method for Determining the Presence or Absence of a Fuel Leak

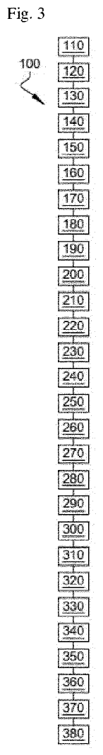

With reference to FIG. 3, a method 100 for determining the presence or absence of a fuel leak in the system 1 is now described. This method is carried out in the system 1 as shown in FIG. 1, that is, wherein the fuel tank 4 is openly connected to the canister 5. This method 100 makes it possible to detect the presence or absence of fuel leaks in the sub-assembly of the fuel tank 4 and the canister 5 isolated from the outside. Thus, the discussion of the presence or absence of fuel leaks in the system 1 relates in practice to the sub-assembly formed by the canister 5 and the fuel tank 4. The method may, however, be carried out in another sub-assembly or in the system as a whole. In this method 100, all the predetermined thresholds and values are either calculated using mathematical functions that will not be described in detail, or are entered by a skilled operator into the data-processing device 3 beforehand. When the predetermined thresholds and values are calculated using mathematical functions, one variable in these mathematical functions is atmospheric pressure.

It should be noted that some of the steps described hereunder make it possible to conclude that there is a fuel leak if the presented tests are passed, but failing these tests does not make it possible to conclude that there is no fuel leak. Other steps, conversely, make it possible to conclude that there is no fuel leak if the presented tests are passed, but failing these tests does not make it possible to conclude that there is a fuel leak. The succession of tests makes it highly likely to conclude on the presence or absence of a fuel leak in the system 1.

It should be noted that all the tests described hereunder are passive, that is, they do not require the generation of suction or vacuuming the fuel system 1 or any other mechanical operation on the containers 4 and 5.

In step 110, the combustion engine 2 of the vehicle is started by a driver of the vehicle. The data-processing device 3 determines a previous period of time during which the combustion engine 2 was stopped before this starting. If this time period is greater than a predetermined time period, in particular two hours, step 120 is carried out. The two-hour period is indeed long enough for the pressure and temperature values measured afterwards to be relevant. Alternatively, step 120 can also be carried out even if this period is not respected, or if this period is configured differently.

In step 120, the device 3 measures a pressure value in the tank using the pressure sensor 11 and measures a temperature value in the tank using the temperature sensor 10.

In step 130, in a first group of steps, the device 3 compares the pressure value, in absolute terms, with a predetermined minimum pressure threshold.

In step 140, when the pressure value is greater, in absolute terms, than the minimum pressure threshold, the device 3 concludes that there is a preliminary indication of the absence of a fuel leak in the system.

Steps 150 and 160 are carried out if there is no preliminary indication upon completion of step 140.

In step 150, in another group of steps, the device 3 compares the pressure value with another predetermined pressure threshold, and compares the temperature with a boiling temperature threshold.

In step 160, when the pressure value is greater, in absolute terms, than the other pressure threshold, and the temperature is below the boiling temperature threshold, the device 3 concludes that there is a preliminary indication of the absence of a fuel leak in the system.

Alternatively, steps 150 and 160 can be carried out first, and steps 130 and 140 are then carried out only if there is no preliminary indication upon completion of step 160.

If there is a preliminary indication of the absence of a fuel leak, this result is stored in memory by the device 3 and may be repeated in step 380, as described hereunder. Thus, on their own, these steps are not conclusive. However, these preliminary indications are taken into account to conclude that there is no fuel leak, if necessary, when steps 170 to 370 described hereunder are not conclusive. These measurements, taken with the engine started, provide an answer to the question of the presence or absence of a fuel leak, even if no conclusion is reached after the steps carried out with the engine stopped. Alternatively, they could be taken into account earlier in the method.

In step 170, the combustion engine 2 of the vehicle is stopped by the driver.

In step 180, the device 3 carries out steps to measure respective pressure values and temperature values in the fuel tank 4 at various predetermined times over a period of time, using the temperature sensor 10 and the pressure sensor 11. This time period herein is six hours. This means that, if the vehicle is restarted before the end of this time period, the steps described from step 190 onwards are not carried out, as the stop period is insufficient. Conversely, as long as the combustion engine 2 is not restarted, the measurements can be scheduled to continue even after the end of this time period. This six-hour duration corresponds to the minimum period required by the CARB standard, to which the invention is adapted. However, this period could be configured to be different. In the present example, the times correspond to points, in the time period from the moment at which the combustion engine 2 stops, and for a duration of six hours, located at 30 minutes, 2.5 hours, 3.5 hours, 4.5 hours, and 6 hours, respectively. They could be scheduled at different times, and be more or less numerous. However, it is advantageous for at least five times to be considered for a six-hour period. Furthermore, it is advantageous not to consider too many times in order to save the energy required by the method for determining the presence or absence of a fuel leak.

In step 190, the device 3 determines the number of times, among the times of step 180, having respective absolute pressure values that are greater than a predetermined pressure threshold.

In step 200, when the number of times determined in step 190 is greater than a predetermined threshold number of times, the device 3 concludes that there is no fuel leak in the sub-assembly formed by the canister 5 and the fuel tank 4 of the system 1, and the method 100 is stopped. None of the steps described subsequently are carried out. The predetermined time threshold can, for example, be three, for a total of five times considered over the six-hour period. It may be different from or depend on the number of measurements performed in step 180, that is, the number of times considered over this time period.

This analysis is particularly quick and easy, as it only involves pressure measurements. It makes it possible to quickly conclude that there is no fuel leak, if necessary, and is based on the observation that, if the pressure has often remained high in the system 1 over time, it is highly unlikely to have a fuel leak.

If no conclusion is reached upon completion of step 200, step 210 is carried out.

In step 210, the device 3 determines, among the times of step 180, the two times for which the respective pressure values are farthest from one another.

In step 220, when an absolute pressure difference value between these two values is smaller than or equal to a predetermined pressure difference threshold, the device 3 concludes that there is a fuel leak in the system. The method is stopped and none of the steps described subsequently are carried out.

Here too, this analysis makes it possible to draw conclusions in a very simple way, without the need for temperatures. It is based on the observation that, if the pressure changes little over time, then it is likely that the system 1 has a fuel leak. The predetermined pressure difference threshold corresponds, in particular, to a threshold below which all the tested systems were found to have fuel leaks.

If no conclusion is reached upon completion of step 220, step 230 is carried out.

In step 230, the device 3 determines the presence or absence, among the times, of two times for which a difference value between the respective temperature values is greater than a predetermined temperature difference threshold, wherein these two times also have respective pressure values that are below a predetermined pressure threshold and greater than the opposite of this pressure threshold. The temperature difference threshold is 3° C. and the pressure threshold depends on the atmospheric pressure, which will not be described herein.

In step 240, when both times of step 230 are determined as being present, the device 3 concludes that there is a fuel leak in the system 1, and the method 100 is stopped.

This analysis is therefore based on the observation that, if over the course of time, and especially over a six-hour period comprising, for example, five measured times over a period of time, there are two times at which the temperature variation is significant and for which the pressures are within specific ranges (between the threshold and the opposite of this threshold), then a fuel leak is likely.

Alternatively, steps 230 and 240 may be carried out before steps 210 and 220, which would only be carried out if no conclusion was reached upon completion of step 240. In another variant, steps 210 and 220 on the one hand, and steps 230 and 240 on the other, are carried out in parallel.

If no conclusion is reached upon completion of steps 200 to 240, step 250 is carried out.

In step 250, the device 3 determines whether at least one of the times has a temperature greater than a predetermined boiling temperature threshold. If this is the case, step 260 is carried out. Otherwise, the method is continued from step 320.

In step 260, when at least one time among the times of step 180 has a temperature value greater than a predetermined boiling threshold, the device 3 determines, among the times, the two times that describe a temperature drop over time and for which the difference between the respective temperature values is the greatest.

In step 270, the device 3 compares this difference between the respective temperature values with a predetermined temperature difference threshold. This threshold is 3° C. It could be different.

In step 280, the device 3 determines the difference between the respective pressure values at these two times.

In step 290, the device 3 compares this difference between the respective pressure values with a predetermined pressure difference threshold. This threshold depends on the atmospheric pressure and will not be described herein.

In step 300, the device 3 compares the pressure of the time, among the two times, which has the lower temperature with a predetermined pressure threshold. This threshold also depends on the atmospheric pressure and will not be described herein.

In step 310, when the difference between the respective temperature values is greater than the predetermined temperature difference threshold, the difference between the pressure values is greater than the pressure value threshold or below the opposite of this threshold, and the pressure of the time that has the lower temperature is greater than the predetermined pressure threshold or below the opposite of this threshold, the device 3 concludes that there is no fuel leak in the system. The following steps are then not carried out, and the method 100 is stopped.

As a result, this analysis is more precise than the others. It is only carried out if there is no conclusion regarding the presence or absence of a fuel leak upon completion of the previous steps, and if at least one of the times has a boiling temperature. The analysis is therefore specific to particularly high temperatures or temperatures that were high at least at some point during the period. Alternatively, it could be carried out earlier in the method 100.

In step 320, when none of the times of step 180 have a temperature value greater than a predetermined boiling threshold, the device 3 determines, among the times, the two times for which the difference between the respective temperature values is the greatest.

In step 330, the device 3 compares this greatest difference between the respective temperature values with a predetermined temperature difference threshold. This threshold is 3° C. but could be different.

In step 340, the device 3 determines the difference between the respective pressure values at these two times.

In step 350, the device 3 compares this difference between the respective pressure values with a predetermined pressure difference threshold. This threshold depends on the atmospheric pressure and will not be described.

In step 360, when the greatest difference between the respective temperature values is greater than the predetermined temperature difference threshold, and the difference between the respective pressure values is greater than the pressure value threshold or below the opposite of this threshold, the device 3 concludes that there is no fuel leak in the system. The method 100 should be stopped.

Thus, this analysis is also more precise than the others and relates to the case where none of the measured temperatures corresponds to boiling. It is only carried out if no conclusion is reached regarding the presence or absence of fuel leaks upon completion of the previous steps. Alternatively, it could be carried out earlier in the method 100.

Alternatively to step 360, this analysis from steps 320 to 350 can be used to conclude that there is a fuel leak. Thus, in step 370, carried out instead of or in parallel with step 360, when the greatest difference between the respective temperature values is greater than the predetermined temperature difference threshold, but the difference between the respective pressure values is below the pressure value threshold or greater than the opposite of this threshold, the device 3 concludes that there is a fuel leak in the system. The method 100 should be stopped.

This step 370 is carried out with the threshold values of steps 330 and 350, but could alternatively be carried out with other threshold values.

Step 380 is only carried out if none of the previous steps have led to a conclusion, that is, the device 3 has not concluded on the presence or absence of a leak. In this case, at this step 380, the device 3 checks whether it has stored the result of steps 100 to 160. Thus, if upon completion of steps 100 to 160, a preliminary indication of the absence of a fuel leak has been determined by the device, then the device 3 concludes, in this step 380, that there is no fuel leak in the system 1.

If no preliminary indication has been made, the device 3 determines that it cannot conclude on the presence or absence of a fuel leak in the system 1. The method can then be continued, that is, the measurements in step 180 are continued, or resumed if they had been stopped, until the combustion engine 2 is restarted. The method can then be repeated, in particular in steps 170 and following, after the combustion engine of the vehicle has been stopped for a further period of at least six hours, for example. The more measurements are spread out over time, the more likely it is that the comparison steps carried out will make it possible to conclude on the presence or absence of a fuel leak.

Prior to the steps described, in the event that the double valve 6 is configured differently to the embodiment shown in FIG. 1, the method 100 for detecting a fuel leak includes steps, carried out by the device 3, which control the opening of the connection between the fuel tank 4 and the canister 5, and the isolation of the fuel tank 4 and the canister 5 from the combustion engine 2 and the atmosphere, in order to return to the configuration shown in FIG. 1, unless this method relates to the second test of the method 400 described hereinafter.

This method 100 is not limited to the embodiments presented, and other embodiments will become clearly apparent to the person skilled in the art.

This method is therefore suitable for any fuel system as defined at the beginning of the text. In particular, it can be carried out for containers other than the fuel tank 4 and the canister 5. In particular, it can be carried out in the fuel tank 4 alone, isolated from the canister 5, or in the canister 5 alone, or in any container in which a pressure sensor and a temperature sensor can be placed and connected to the data-processing device 3.

### II. Method for Locating a Fuel Leak

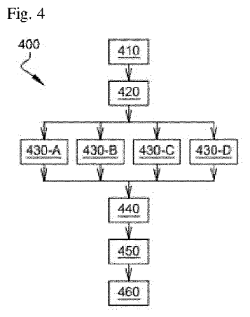

A method 400 for locating a fuel leak in a fuel system will now be described, with reference to FIG. 4.

In step 410, with the system 1 comprising a fuel tank 4 and a canister 5 openly connected to each other, as illustrated in FIG. 1, the device 3 performs a first test to determine the presence or absence of a fuel leak in said system 1 comprising the fuel tank 4 and the canister 5. This first test corresponds to the method 100 described hereinbefore. It therefore makes it possible to detect the presence or absence of a fuel leak in the sub-assembly formed by the fuel tank 4 and the canister 5.

In step 420, when the presence of a fuel leak is determined upon completion of the first test, that is, upon completion of the method 100, the device 3 closes the connection, via the double valve 6, between the fuel tank 4 and the canister 5 so as to isolate the two containers from one another. The system 1 is then in the configuration shown in FIG. 2. The rest of the method 400 takes place on the system configured in this state.

In step 430-A, the device 3 immediately begins a second test to determine the presence or absence of a fuel leak in the first container. This is the same method 100, carried out for the second time, with the exception of steps 110 to 160, since the combustion engine 2 is stopped. Thus, steps 170 and following are repeated until the method 100 is stopped as previously described. This time, however, the fuel tank 4, in which the temperature and pressure measurements are carried out, is isolated from the canister 5. The detection of a fuel leak therefore only relates to the fuel tank 4. This second test, carried out immediately after the first test, comprises a period of time corresponding to step 180, which lasts until the combustion engine 2 is restarted. In this step, the times corresponding to the pressure and temperature measurements in the fuel tank 4 are separated by thirty minutes. This interval could be different. The number of times therefore depends on this duration and these intervals. Generally speaking, the longer the period of time, that is, the longer the vehicle remains stationary, the more likely it is that this second test will result in the detection of a leak or of the absence of a fuel leak in the fuel tank 4.

In an alternative step 430-B, the time period of this second test is predetermined to last two hours. This time is generally sufficient to allow a sufficient number of measurements, thus enabling the device 3 to conclude on the presence or absence of a fuel leak in the fuel tank 4. In addition to the six-hour time period for the first test, there is a two-hour time period for this second test.

In an alternative step 430-C, the time period of the first test, performed when the connection between the fuel tank 4 and the canister 5 is open, is configured to last four hours instead of six hours when it is associated with the second test. Adding the two-hour time period for this second test, the combination of the first and second tests lasts six hours, providing a six-hour fuel leak detection and location method that complies with the CARB (California Air Resources Board) standard, while optimizing the time taken by each of the two tests.

In an alternative step 430-D, this second test does not start immediately after the first. Thus, when the first test results in the detection of a fuel leak, this result is stored in memory by the device 3. The combustion engine of the vehicle is then restarted by the driver, and it is not until the next cycle, that is, the next time the combustion engine 2 is stopped, that the second test begins, with the connection between the fuel tank 4 and the canister 5 closed. In other words, since the stopping of the combustion engine 2 is a first stop, the second test is carried out after a second stopping of the combustion engine 2, itself following a restart of the combustion engine 2 after the first test. In this alternative, the time period of the measurements of step 180 is predetermined to last six hours for this second test. This second test is therefore carried out under the same conditions as the first test, which increases the chances of reaching a conclusion regarding the presence or absence of a fuel leak in the fuel tank 4. It is noted that, for any second test, the connection between the fuel tank 4 and the canister 5 must be closed, a connection which may have been reopened in the meantime when the combustion engine 2 was restarted.

In step 440, when the presence of a fuel leak is detected upon completion of the second test, the device 3 concludes that a fuel leak is located in the fuel tank 4, or when the absence of a fuel leak is detected upon completion of the second test, the device 3 concludes that a fuel leak is located in the canister 5. Indeed, since it is already known, by virtue of the result of the first test, that the sub-assembly formed by the fuel tank 4 and the canister 5 is leaking, closing the connection between the fuel tank 4 and the canister 5 and repeating the method 100 for this second test makes it possible to determine whether the fuel leak relates to the fuel tank 4 or the canister 5.

The following steps are carried out if the device does not reach a conclusion upon completion of the second test.

In step 450, if no conclusion is reached regarding the location of the fuel leak upon completion of the second test, after the combustion engine 2 has been stopped following a restart of the combustion engine following the second test, the device 3 carries out a step to close the connection between the fuel tank 4 and the canister 5 of the system 1, so as to isolate these two containers from one another once again. Indeed, since the combustion engine has been restarted, this connection may be open. This step thus returns to the same state as in FIG. 2.

In step 460, the device performs a third test to determine the absence or presence of a fuel leak in the fuel tank 4 of the system, continued for a predetermined period of time of at least six hours. This third test is the same as the second test, that is, the method 100, with the exception of steps 110 to 160.

Thus, this third test takes place when the second test has been interrupted by a restart of the vehicle before the predetermined time period has been reached, or when the device 3 has been unable to reach a conclusion regarding the location of the fuel leak. The search for the location of the leak can be extended by repeating these steps 170 and following in the tank isolated from the outside, on the next cycle, that is, when the combustion engine 2 is stopped again.

Fourth, fifth and further tests can follow each time the combustion engine 2 is stopped, still in the isolated fuel tank 4, until the fuel leak has been located. Alternatively, it may be possible to stop these tests. It may especially be possible to repeat the first test, that is, the detection of the presence or absence of a fuel leak in the subsystem formed by the fuel tank 4 and the canister 5, when the device 3 has been unable to locate the fuel leak after a number of tests in the isolated fuel tank 4.

It should be noted that all these tests are passive since they do not require the generation of suction or vacuuming the fuel system 1 or any other mechanical operation on the containers 4 and 5.

This disclosure also relates to a fuel system 1 for a vehicle provided with a combustion engine 2 comprising:
a first container and a second container, the fuel tank 4 and the canister 5, connected to each other;
a valve 6 for opening and closing the connection between the first container and the second container;
a device 3 for carrying out the steps of methods 100 and 400.

The invention is not limited to the embodiments presented, and other embodiments will become clearly apparent to the person skilled in the art.

In particular, the invention is not limited to the fuel tank 4 and the canister 5, but can be carried out for all types of containers, connected to each other by a connection that can be opened and closed.

Additionally, instead of the detection method 100, any method for detecting the presence of a fuel leak in a container is covered by the method 400. Indeed, the invention aims to use a method for detecting a fuel leak at least twice in order to locate the leak. In this way, it is not limited to a particular method for detecting a fuel leak. It is also possible for the first and second tests not to include the same steps of detecting a fuel leak.

Finally, it should be noted that, instead of the double valve 6, a standard single valve, of FTIV type, is sufficient to isolate the connection between the tank 4 and the canister 5.

### LIST OF REFERENCES

1: fuel system
2: combustion engine of a vehicle
3: data-processing device
4: fuel tank
5: canister
6: double valve
7: processor
8: computer-readable storage medium
9: computer program
10: temperature sensor
11: pressure sensor
12: atmosphere
100: method for determining the presence or absence of a fuel leak
400: method for locating a fuel leak

1. A method for locating a fuel leak in a pressurized fuel system for a vehicle provided with a combustion engine the method comprising:
since the system comprises a first container and a second container openly connected to each other, a first passive test for determining the presence or absence of a fuel leak in said system comprising the first container and the second container;
when the presence of a fuel leak is determined upon completion of the first test:
closing the connection between the first container and the second container so as to isolate the two containers from one another;
carrying out a second passive test for determining the presence or absence of a fuel leak in the first container
when the presence of a fuel leak is detected upon completion of the second passive test concluding that a fuel leak is located in the first container or when the absence of a fuel leak is detected upon completion of the second test, concluding that a fuel leak is located in the second container
the first and second passive tests being passive in that they do not require suction generation or vacuuming the fuel system or any other mechanical operation on the first container and the second container.

2. The method according to claim 1, wherein the first passive test comprises:
after the combustion engine of the vehicle has been stopped measuring respective pressure values in the system at various predetermined times over a period of time;
determining among the times, the two times for which the respective pressure values are farthest from one another;
when an absolute pressure difference value between these two values is smaller than or equal to a predetermined pressure difference threshold, concluding that there is a fuel leak in the system and stopping the method

3. The method according to claim 1, wherein the first and second passive tests for determining the presence or absence of a fuel leak comprise:
measuring pressure and temperature values in the first container of the system at various predetermined times in respective first and second time periods;
comparing at least one of the values with a predetermined threshold.

4. The method according to claim 1, wherein the first passive test is carried out following a stopping of a combustion engine of the vehicle and for a predetermined period of time.

5. The method according to claim 4, wherein the second passive test is carried out immediately after completion of the first passive test (410) when the presence of a fuel leak has been detected upon completion of this first passive test (410).

6. The method according to claim 5, wherein the second passive test is continued for a predetermined period of time.

7. The method according to claim 5, wherein the second passive test is continued until the vehicle provided with a combustion engine is restarted.

8. The method according to claim 1, wherein since the stopping of the combustion engine is a first stop, the second passive test is carried out after a second stopping of the combustion engine itself following a restart of the combustion engine subsequent to the first passive test, the second passive test being continued for a predetermined period of time.

9. The method according to claim 5, comprising, if no conclusion is reached regarding the location of the fuel leak upon completion of the second passive test, after stopping the combustion engine itself following a restart of the combustion engine subsequent to the second passive test, the following steps:
closing the connection between the first container and the second container of the system so as to isolate the two containers from one another;
carrying out a third passive test to determine the absence or presence of a fuel leak in the first container of the system continued for a predetermined period of time, the third test being passive since it does not require the generation of suction or vacuuming the fuel system or any other mechanical operation on the first container and the second container.

10. The method according to claim 1, wherein the first container of the system is a fuel tank and the second container is a canister, the opening and closing of the connection being operated by a valve.

11. A data-processing device comprising a processor suitable for the steps of the method according to claim 1 in order to carry out of the method.

12. A fuel system for a vehicle provided with a combustion engine comprising:
a first container and a second container connected to each other;
a valve for opening and closing the connection between the first container and the second container;
a device according to claim 11.

13. A vehicle provided with a combustion engine comprising a fuel system according to claim 12.

14. A computer program comprising instructions which, when the program is executed by a computer, cause the computer to carry out the method according to claim 1.

15. A computer-readable storage medium comprising instructions which, when executed by a computer, cause the computer to carry out the method according to claim 1.
